(19) United States
(12) Patent Application Publication
(10) Pub. No.: US 2023/0013096 A1
(43) Pub. Date: Jan. 19, 2023

(54) TARPAULIN AND ANTI-FALLING MESH TARPAULIN SPECIAL FOR DUMP TRUCK

(71) Applicant: Hebei Sameite New Material Co., Ltd., Hebei (CN)

(72) Inventor: Zhimou Zhao, Hebei (CN)

(21) Appl. No.: 17/305,887

(22) Filed: Jul. 16, 2021

(51) Int. Cl. B60J 7/16

(52) U.S. Cl. CPC B60J 7/1607

(57) ABSTRACT

A tarpaulin and anti-theft falling mesh tarpaulin special for a dump truck are provided and each include a body which is made of a polyvinyl chloride (PVC) tarpaulin and is integrated with a fixing rod connecting end, a power shaft connecting hole and binding strip connecting loops by cutting, edge wrapping, and sewing of the body.

### TECHNICAL FIELD

The present disclosure relates to a tarpaulin and anti-falling mesh tarpaulin special for a dump truck and a structure thereof, and in particular, to a structure of a polyvinyl chloride (PVC) tarpaulin and PVC mesh tarpaulin.

### BACKGROUND ART

With the acceleration of urban construction, construction waste clearing trucks are commonly used during construction, and the trucks for transporting construction waste are increasing. Such trucks usually have poor sealing performance, some construction waste may fall out of the trucks and cause serious environmental pollution during transportation. The traditional iron tarpaulin is heavy in weight, and has the disadvantages of high cost, difficulty in operation, low automation degree and the like. In view of the foregoing, it would be desirable to provide a system that would overcome these and other disadvantages.

### SUMMARY

The technical problem to be solved by the embodiments are to provide a product that is light, easy to install, low in cost, high in automation degree, easy to operate, good in sealing performance, and strong in environmental protection function compared with the conventional iron truck cover, and is combined with a tarpaulin power system of a dump truck. The structure of the present disclosure includes a body, a power shaft connecting hole, a fixing rod connecting end, and binding strip connecting loops.

In some embodiments, the body may be a PVC tarpaulin or PVC mesh tarpaulin.

In some embodiments, the PVC tarpaulin may be of 300 to 650 g/m².

In some embodiments, the PVC mesh tarpaulin may be a Textilinene, and of 200 to 350 g/m².

In some embodiments, the body may be processed through a sewing process by a sewing machine.

In some embodiments, the fixing rod connecting end may be formed by sewing a polyester ribbon to the body.

In some embodiments, the power shaft connecting hole may be a hole with a diameter of 6 inch and formed by folding the body back by 15 cm and sewing a fold-back end with the body.

In some embodiments, the binding strip connecting loops may be copper eyelet loops.

The embodiments have the beneficial effects that: since the PVC tarpaulin used in the product has sealing performance, dust in a truck bed is not prone to disperse to cause environmental pollution during use. The PVC mesh tarpaulin can be used when solid matters are loaded in the truck bed. The PVC mesh tarpaulin has the characteristics of lightness, easiness in operation, and capacity of protecting the matters in the truck bed from falling off during use. The power shaft connecting hole formed in the structure of the product can be combined with the tarpaulin power system of the dump truck, so that the present disclosure is high in automation degree and convenient to operate. The binding strip connecting loops facilitate closer coverage of the product to the truck bed, and enhance the sealing performance of the present disclosure, thereby achieving the performance of environmental protection and safety.

### BRIEF DESCRIPTION OF THE DRAWINGS

FIG. 1 is a schematic diagram of a whole structure of the present disclosure, and

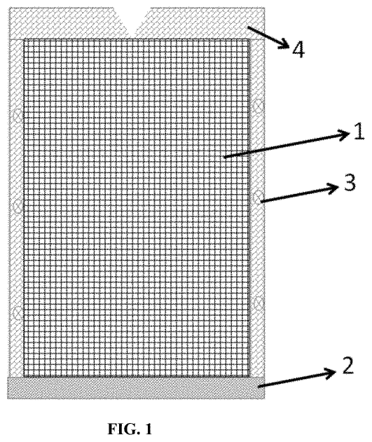

FIG. 2 is an actual installation effect diagram of the present disclosure.

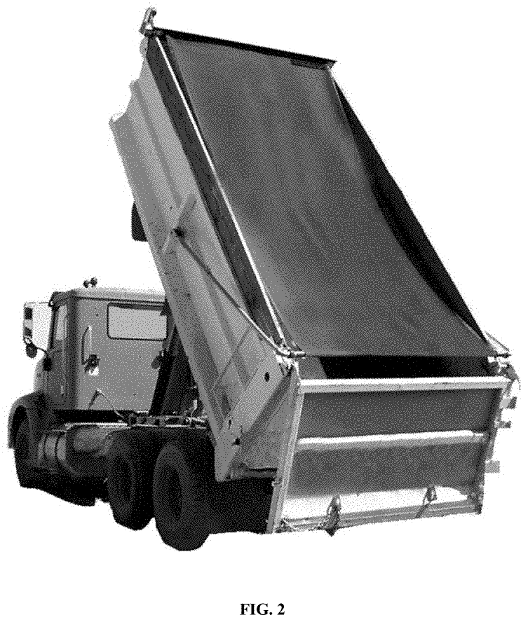

### DETAILED DESCRIPTION OF THE EMBODIMENTS

The present disclosure is further described below with reference to the accompanying drawings. However, the scope of protection of the present disclosure is not limited to this.

The present disclosure relates to a tarpaulin and anti-falling mesh tarpaulin special for a dump truck, which includes a body 1 made of PVC tarpaulin or PVC mesh tarpaulin, a power shaft connecting hole 2, binding strip connecting loops 3 and fixing rod connecting end 4. The power shaft connecting hole 2 is a hole with a diameter of 6 inch and is formed by folding the body back by 15 cm and sewing a fold-back end with the body. Further, the power shaft connecting hole 2 is connected to a tarpaulin power system 5 of the dump truck. The fixing rod connecting end 4 is connected to the tarpaulin power system 5 of the dump truck. The body 1 is controlled to unwind and wind by the tarpaulin power system 5 of the dump truck.

The present disclosure is used with a tarpaulin power system of the dump truck and has the advantages of lightness and easiness in installation, low cost, high automation degree, easiness in operation, good sealing performance, strong environmental protection function and the like, compared with the conventional iron truck cover. Thus, the present disclosure is better than the conventional cover of the dump truck.

1. A tarpaulin special for a dump truck, comprising a body which is made of a polyvinyl chloride (PVC) tarpaulin and is integrated with a fixing rod connecting end, a power shaft connecting hole and binding strip connecting loops by cutting, edge wrapping, and sewing of the body.

2. The tarpaulin according to claim 1, wherein the tarpaulin is processed through a sewing process by a sewing machine.

3. The tarpaulin for a dump truck according to claim 1, wherein the body is made of the PVC tarpaulin.

4. The tarpaulin according to claim 3, wherein the PVC tarpaulin is of 300 to 650 g/m².

5. The tarpaulin according to claim 1, wherein the fixing rod connecting end is formed by sewing a polyester ribbon to the body.

6. The tarpaulin according to claim 1, wherein the binding strip connecting loops are copper eyelet loops.

7. The tarpaulin according to claim 1, wherein the power shaft connecting hole is a hole with a diameter of 6 inches and formed by folding the body back by 15 cm and sewing a fold-back end with the body.

8. An anti-theft falling mesh tarpaulin special for a dump truck, comprising a body which is made of a polyvinyl chloride (PVC) mesh tarpaulin and is integrated with a fixing rod connecting end, a power shaft connecting hole and binding strip connecting loops by cutting, edge wrapping, and sewing of the body.

9. The anti-theft falling mesh tarpaulin according to claim 8, wherein the anti-theft falling mesh tarpaulin is processed through a sewing process by a sewing machine.

10. The anti-theft falling mesh tarpaulin for a dump truck according to claim 8, wherein the body is made of the PVC mesh tarpaulin.

11. The anti-theft falling mesh tarpaulin according to claim 10, wherein the PVC mesh tarpaulin is a Textilene, and of 200 to 350 g/m².

12. The anti-theft falling mesh tarpaulin according to claim 8, wherein the fixing rod connecting end is formed by sewing a polyester ribbon to the body.

13. The anti-theft falling mesh tarpaulin according to claim 8, wherein the binding strip connecting loops are copper eyelet loops.

14. The anti-theft falling mesh tarpaulin according to claim 8, wherein the power shaft connecting hole is a hole with a diameter of 6 inch and formed by folding the body back by 15 cm and sewing a fold-back end with the body.
